(19) United States
(12) Patent Application Publication
(10) Pub. No.: US 2024/0166535 A1
(43) Pub. Date: May 23, 2024

(54) Stabilized Electrodes

(71) Applicant: Leibniz-Institut für Neue Materialien gemeinnützige GmbH, Saarbrücken (DE)

(72) Inventors: Volker Presser, Saarbrücken (DE); Lei Wang, Saarbrücken (DE); Srimuk Pattarachai, Saarbrücken (DE)

(21) Appl. No.: 18/283,838

(22) PCT Filed: Mar. 24, 2022
(86) PCT No.: PCT/EP2022/057760

§ 371 Date: Sep. 25, 2023

(30) Foreign Application Priority Data
Apr. 1, 2021 (DE) 10 2021 108 464.4

(51) Int. Cl. C02F 1/461; B01D 61/42; B01D 61/46; C02F 1/469; C02F 103/08; C02F 103/10

(52) U.S. Cl. CPC C02F 1/46109; B01D 61/428; B01D 61/461; C02F 1/4691; B01D 2313/345; C02F 2001/46138; C02F 2103/08; C02F 2103/10

(57) ABSTRACT

An electrode material for extracting an elemental ion from a liquid medium includes at least one electrode material having at least one ion sieve that is capable of retaining or releasing an elemental ion, or a mixture of such ion sieves, wherein the ion sieve or ion sieves is or are coated with carbon.

### FIELD OF THE INVENTION

The invention relates to an electrode material for extracting an element ion from a liquid medium.

### PRIOR ART

Demand for lithium-ion based rechargeable energy storage has increased dramatically as a consequence of the expected sharp rise in the use of mobile electronics and electric vehicles powered by lithium-ion batteries. It is projected that between 2015 and 2050 five million tons of lithium, more than a third of the total lithium reserves available on land, will be consumed and lithium reserves could be exhausted by 2080. Currently, most lithium is extracted from brine on account of its relatively low cost and richer reserves compared to mineral resources. There is a great demand for low-cost, environmentally friendly methods that are able to produce lithium quickly and in large amounts. A number of methods exist for extracting lithium from brine, such as solar evaporation, adsorption, and electrolysis. Although the solar evaporation method is the most widespread, it is both time- and space-consuming. Adsorption methods require large amounts of acids for regeneration, and electrolysis processes suffer from relatively low lithium recovery efficiency and membrane fouling. There is consequently a need to develop advanced, sustainable, and effective lithium recovery technologies.

Electrochemical processes are particularly promising for lithium extraction because of the simplicity of the process, the energy efficiency, and the high lithium selectivity. In the 1993 study by Kanoh et al. λ-MnO₂ (lithium extraction) and Pt (O₂ production) were introduced as electrodes for lithium extraction. (Kanoh, H.; Ooi, K.; Miyai, Y.; Katoh, S., Electrochemical recovery of lithium ions in the aqueous phase. Separation Science and Technology 1993, 28, (1-3), 643-651.) Pasta et al. in 2012 introduced a new cell concept in which lithium iron phosphate (LiFePO₄) and silver serve as cathode and anode respectively (Pasta, M.; Battistel, A.; La Mantia, F., Batteries for lithium recovery from brines. Energy & Environmental Science 2012, 5, (11), 9487). In this cell, one cycle comprises two half-cycle processes of capture and release. During charging, the lithium and chloride ions are captured by iron phosphate and silver respectively; during discharging the ions are released from the electrodes into the solution. In the years that followed, the results of many studies of lithium extraction from brine were reported, the procedure in nearly all cases being based on LiFePO₄ on account of the high selectivity and green production process of LiFePO₄. For example, Trócoli et al. (Trócoli, R.; Battistel, A.; La Mantia, F., Nickel hexacyanoferrate as suitable alternative to Ag for electrochemical lithium recovery. ChemSusChem 2015, 8, (15), 2514-2519) reported on the use of a cell having LiFePO₄ and NiHCFe as electrodes for the extraction of lithium from Atacama brines; the lithium concentration in the feed water increased from 4% to 11%, with an energy consumption of 8.7 Wh/mol. Kim et al. used polydopamine-coated LiFePO₄ and Pt immersed in I⁻/I₃⁻ as electrodes; this cell achieved a >4000-fold increase in Li/Na ion selectivity (Kim, J.-S.; Lee, Y.-H.; Choi, S.; Shin, J.; Dinh, H.-C.; Choi, J. W., An electrochemical cell for selective lithium capture from seawater. Environmental Science & Technology 2015, 49, (16), 9415-9422). In these studies, the stability of the electrons was in most cases not investigated. It is also not known whether cations present in addition to lithium, such as Na⁺, Ca²⁺, and Mg²⁺, adversely affect the stability of LiFePO₄.

However, for effective use of the electrodes, especially for water treatment, a higher cycle stability with a lower loss of capacity is necessary. The stability of known electrode materials is inadequate for this.

### Object

The object of the invention is to specify an electrode material having improved stability, in particular for use in aqueous solutions, and also the use of such an electrode material and a process for the treatment of water.

The object is achieved by the inventions having the features of the independent claims. Advantageous developments of the inventions are characterized in the subclaims. The wording of all claims is hereby made part of the content of this description by reference. The inventions also encompass all reasonable and in particular all recited combinations of independent and/or dependent claims.

The invention relates to an electrode material for extracting an element ion from a liquid medium, comprising at least one electrode material comprising at least one ion sieve capable of intercalating or releasing an element ion, or a mixture of such ion sieves, the ion sieve(s) being coated with carbon.

The electrode material is surprisingly suitable for CDI (capacitive deionization) or FDI (faradaic deionization).

Surprisingly, it was found that such coating of the ion sieve significantly increases the stability of the ion sieve and thus of the electrode material too, without there being any extraction losses. The coating also improves the tolerance of other cations in the liquid medium, for example potassium ions, sodium ions or magnesium ions.

The extraction is preferably a desalination, especially CDI or FDI.

Desalination here means that ions from a medium surrounding the electrodes undergo intercalation in the electrode.

In a preferred embodiment, this element ion is a lithium ion.

The ion sieve can be in the form of a depleted ion sieve (a delithiated ion sieve in the case of lithium) or a lithium-intercalated ion sieve. In the lithium-intercalated form it is preferably a lithium-containing metal oxide, which may also be a complex oxide, or a lithium-containing metal phosphate. It is preferably a complex oxide containing lithium and at least one further element selected from Co, Mg, Cr, Mn, Ni, Fe, Al, Mo, V, W or Ti. It may be LiNiO₂, LiCoO₂, LiMn₂O₄, LiNi_{0.34}Mn_{0.33}Co_{0.33}O₂ or a lithium iron phosphate or a mixture thereof.

Preference is given to a lithium iron phosphate, LiMn₂O₄ or a mixture thereof The lithium iron phosphate is preferably selected from LiFePO₄, LiₓMe_{y}FePO₄, LiFeMeYPO₄ or a mixture thereof, where Me is Mn, Co, Mo, Ti, Al, Ni, Nb or a mixture thereof and 0<x<1; and 0<y<1.

Depending on the use, it may be necessary to convert the ion sieve from the lithium intercalated form into the depleted form.

The lithium-intercalated ion sieve is coated with a carbon layer. This layer is preferably obtained by carbonization, especially by carbonization of alkyl esters and of crosslinked polyalkyl esters in particular. Preferred electrode materials here are LiFePO₄/C, LiₓMe_{y}FePO₄/C, and LiFeₓMe_{y}PO₄/C, especially LiFePO₄/C. The carbonization affords a thin and at the same time permeable layer. The layer preferably comprises graphitic carbon. The carbon can also be entirely graphitic.

A layer thickness of at least 2 nm (measured with TEM) is preferable.

The coated ion sieve is preferably obtained by carbonization of an ion sieve having a specific surface area of at least 10 m²/g. The carbonization is preferably carried out using the lithium-intercalated form.

In a preferred embodiment, the ion sieve is in the form of particles. Preferably having a maximum dimension of 2 μm, preferably 1 μm (measured with TEM), more preferably 700 μm. The minimum dimension of the particles is independently thereof at least 10 nm, especially at least 20 nm.

The ion sieve is preferably in crystalline form.

In a preferred embodiment, the particles are coated with the carbon layer.

The invention relates also to an electrode for extracting an element ion from a liquid medium, comprising as electrode material at least one ion sieve capable of intercalating or releasing an element ion, or a mixture of such ion sieves, the ion sieve(s) being coated with carbon.

The electrode may also include further elements, such as carrier materials or matrix materials.

The liquid medium is preferably water. The at least one ion sieve is preferably the ion sieve as described for the electrode.

The invention relates also to a process for extracting an element ion using at least one electrode material of the invention. The element ion is preferably a lithium ion.

Individual process steps are more particularly described hereinbelow. The steps need not necessarily be carried out in the stated order and the process to be described may also have further steps not mentioned.

In the process, the intercalation and release of the element ion can be controlled by applying a particular voltage. This allows the element ion to be selectively extracted from the surrounding medium, especially water, and also to be released back therein. If this takes place in different media, it is possible to deplete the element ion in one medium while releasing it in another medium. For example, this makes it possible to selectively deplete this element ion from aqueous media in particular. Intercalation and release here correspond to a cycle that is repeated over and over again.

The carbon coating makes it possible for the intercalation capacity of the electrode to decrease significantly less than would be the case without this coating. This is what makes it possible to use the ion sieve of the invention economically in such processes at all.

The lithium-intercalated ion sieve is coated with a carbon layer. This layer is preferably obtained by carbonization, especially by carbonization of alkyl esters and of crosslinked polyalkyl esters in particular. The carbonization can preferably be achieved by coating the ion sieve in an ester and then carbonizing at temperatures of above 600° C. The ion sieve is preferably dispersed in a mixture of a hydroxyl compound and a carboxylic acid and, preferably after formation of the ester, heated to above 100° C., preferably 101 to 300° C., especially 150° C. to 250° C., preferably 200° C., to remove any water that may be present. After 1 to 5 hours, the mixture is heated to above 500° C., preferably 501° C. to 900° C., especially 550° C. to 800° C., very particularly 600° C. to 800° C., very particularly 700° C. This is preferably done for over 4 hours, preferably 4 to 7 hours. The carbonization, preferably both thermal treatments, are carried out under low-oxygen, preferably oxygen-free conditions, preferably under an inert gas such as nitrogen or argon. The mass ratio between the ion sieve and the mixture of hydroxyl compound and carboxylic acid is preferably between 3:1 and 1:3, preferably 2:1 to 1:2, very preferably 1.2:1 and 1:1.2, especially 1.1:1 and 1:1.1. The hydroxyl compound and the carboxylic acid are preferably compounds having a molecular mass of less than 400 g/mol. The hydroxyl compound can be used here in excess relative to the carboxylic acid, based on the ratio of hydroxyl groups to carboxylic acid groups. Preferred hydroxyl compounds are alcohols such as methanol, ethanol, propanol, butanol, diols, such as ethylene glycol, propane-1,3-diol, polyethylene glycol, butane-1,4-diol, pentane-1,5-diol, octane-1,8-diol, and triols such as glycerol, preference being given to alcohols having more than one hydroxyl group, especially diols.

Examples of carboxylic acids, which preferably contain 1 to 24 carbon atoms, are monocarboxylic acids (for example formic acid, acetic acid, propionic acid, butyric acid, pentanoic acid, hexanoic acid, capric acid, stearic acid, phenylacetic acid, benzoic acid, polycarboxylic acids having two or more carboxyl groups (for example oxalic acid, malonic acid, adipic acid, succinic acid, glutaric acid, phthalic acid, trimesic acid, trimellitic acid), unsaturated carboxylic acids (for example acrylic acid, methacrylic acid, crotonic acid, maleic acid, fumaric acid, and oleic acid) and hydroxy carboxylic acids (for example glycolic acid, lactic acid, malic acid, and citric acid).

Preference is given to one or more carboxylic acids having more than one carboxylic acid group, especially in combination with a hydroxyl compound having more than one hydroxyl group. This affords a crosslinked polyester compound as an intermediate, which is then carbonized, particularly preferably a tricarboxylic acid such as citric acid, especially with a diol such as ethylene glycol. The carboxylic acids are preferably used in anhydrous form.

For the formation of the ester it may be necessary to heat the composition to up to 100° C., preferably up to 90° C., especially to 30° C.-100° C., especially 50° C.-90° C. This treatment is preferably carried out for at least 1 hour, especially at least 2 hours, preferably 1 to 10 hours, preferably 2 to 8 hours, especially 3 to 5 hours. This treatment affords an ion sieve coated with the ester.

It is also possible to use other catalysts such as metal compounds, for example ferrocene. However, this is not preferred.

This carbonization results in a particularly homogeneous, thin, and sufficiently porous carbon layer on the ion sieve.

In one embodiment, the invention relates to a process for selectively extracting lithium from an aqueous solution and recovering and concentrating lithium in salt brine, comprising the following steps:
a) providing an apparatus comprising a cell for accommodating the salt brine; filling the cell with salt brine;
b) placing a conductive substrate coated with an ion sieve in the cell and placing a further conductive substrate in the cell, at least one of the two conductive substrates and—during performance of the process—the ion sieve being capable of intercalating or releasing Li⁺. Depending on the procedure for the process and the nature of the conductive substrates used, the procedure for the process may vary in respect of salt brine replacement and division of the cell into subcells, which are optionally separated by a membrane. This is the case especially when the additional conductive substrate is not an ion sieve but a chemically neutral electrode such as activated carbon. This can simplify the structure of the cell.

The electrode can preferably be used in a cell for capacitive deionization (CDI), especially a through-flow cell.

In one embodiment, the invention relates to a process for selectively extracting lithium from an aqueous solution and recovering and concentrating lithium in salt brine, comprising the following steps:
a) providing an apparatus for electrodialysis, comprising an electrodialysis cell, dividing the electrodialysis cell into a lithium salt chamber and an alkali chamber by means of an anion-exchange membrane; filling the alkali chamber with salt brine; and filling the lithium salt chamber with a supporting electrolyte solution, such as a solution of NaCl, KCl, NH₄Cl, Na₂SO₄, K₂SO₄, NaNO₃ or KNO₃;
b) placing a conductive substrate coated with a depleted ion sieve in the alkali chamber to act as a cathode, placing a conductive substrate coated with a lithium-intercalated ion sieve in the lithium salt chamber to act as an anode, wherein at least one of the two conductive substrates, preferably both, includes the ion sieve of the invention as the electrode material, and wherein, during the performance of the electrodialysis, the ion sieve is capable of intercalating Li⁺ in the alkali chamber in order to undergo transformation into another lithium-intercalated ion sieve under an external electric potential, the lithium-intercalated ion sieve being capable of releasing Li⁺ into a conductive solution in order to undergo transformation into another ion sieve under the external electric potential, wherein after the intercalation and release of Li⁺ by the depleted ion sieve and the lithium-intercalated ion sieve respectively, enrichment occurs in the lithium salt chamber to afford a lithium-enriched solution.

After step 2), Li⁺ in the alkali chamber undergoes intercalation into the ion sieve, which thereby becomes transformed into the lithium-intercalated ion sieve, while the lithium-intercalated ion sieve in the lithium salt chamber releases Li⁺ into the conductive solution and is transformed into the ion sieve. The two electrodes can accordingly be reused by reversing their positions.

Thus, after step 2) the following step can be performed: draining a liquid from the alkali chamber after lithium intercalation; refilling the alkali chamber with the salt brine; reversing the positions of the cathode and the anode; and continuing the electrodialysis.

Optionally, it is possible after step 2), in order to avoid reversing the positions of the cathode and the anode, to perform the following step to separate Li⁺ from other cations and enrich Li⁺:
maintaining the positions of the cathode and anode; draining a liquid from the alkali chamber after lithium intercalation; transferring a lithium solution from the lithium salt chamber to the alkali chamber; and refilling the lithium salt chamber with the salt brine; i.e. switching the functions of the alkali chamber and the lithium salt chamber and continuing the electrodialysis. Accordingly, when the above process is repeated, the functions of the alkali chamber and the lithium salt chamber are switched.

When the electrodes are to function as an ion sieve, it is preferable that only the electrode material of the invention is employed therein in order that the electrodes achieve high stability over many cycles. This allows better extraction of the lithium to be achieved. The presence of other cations such as Mg²⁺, Ca²⁺ or Na⁺ is also tolerated better.

The salt brine is selected from a solution containing lithium ions, a primary salt brine, an evaporated salt brine, an evaporated salt brine after potassium extraction, or a mixture thereof. It can be liquid from geothermal energy generation or similar process liquids.

The conductive substrate is a ruthenium-coated titanium mesh, a graphite plate, a platinum group metal or alloy foil thereof, a carbon fabric or a graphite foil.

Process parameters are as follows: solution temperature: 0-80° C.; pH: 2-12; and voltage between the two electrodes: 0.5-2 V.

In one embodiment of the invention, the concentration of the oxygen dissolved in the medium is lowered, preferably during the intercalation of the element ion. This is preferably achieved by purging the medium with a non-oxidizing gas, preferably nitrogen. This expels the oxygen from the medium.

The lowering of the oxygen content increases the stability of the electrode further. This process can also be employed to increase the cycle stability of uncarbonized ion sieves.

The invention therefore relates also to a process for extracting an element ion from a liquid medium, comprising an electrode material as described according to the invention, it being possible also for the material to have no carbon layer, wherein the oxygen content of the medium has been lowered by purging with a non-oxidizing gas. This gas is preferably nitrogen. The process is preferably performed using an electrode material of the invention.

The invention relates also to an apparatus for performing the process of the invention. Such an electrodialysis apparatus comprises at least one electrodialysis cell divided into a lithium salt chamber and an alkali chamber by means of an anion-exchange membrane; and at least one cathode and at least one anode, the cathode and the anode being respectively arranged in the two chambers and the cathode and anode comprising as electrode material the ion sieve of the invention in the corresponding form.

A further aspect of the invention comprises the use of the ion sieve of the invention in a process for extracting the element ion from a liquid medium, preferably an aqueous medium, especially water.

A further aspect of the invention comprises the use of an electrode of the invention in a process for extracting the element ion from a medium, preferably an aqueous medium.

Particularly suitable as a medium for extracting element ions, especially lithium, are industrial waste water or process liquids such as battery recycling solution or rinsing liquids, or waste water from mining such as mine water. It can also be liquids obtained from boreholes, for example from hydrothermal sources or from geothermal energy generation or heat pumps.

Further details and features are apparent from the following description of preferred exemplary embodiments in conjunction with the subclaims. The respective features may be realized alone or in combination with one another. The options for achieving the object are not limited to the exemplary embodiments.

Thus for example, indicated ranges always include all intermediate values and all conceivable subintervals not mentioned.

The exemplary embodiments are shown schematically in the figures. Identical reference numbers in the individual figures indicate identical or functionally identical elements or elements that correspond to one other in their functions. In the figures are shown, more particularly:

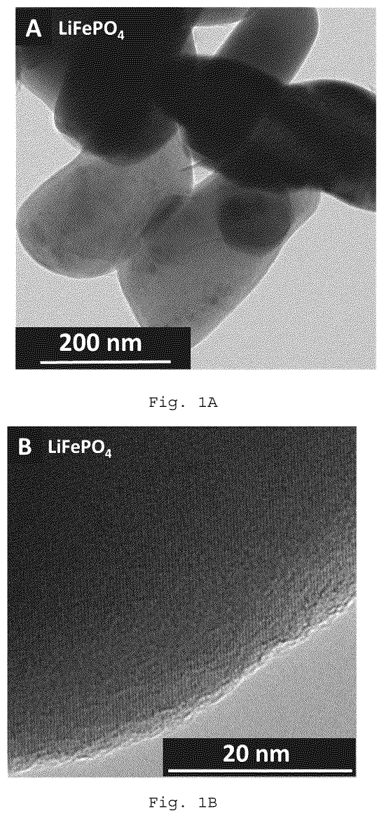

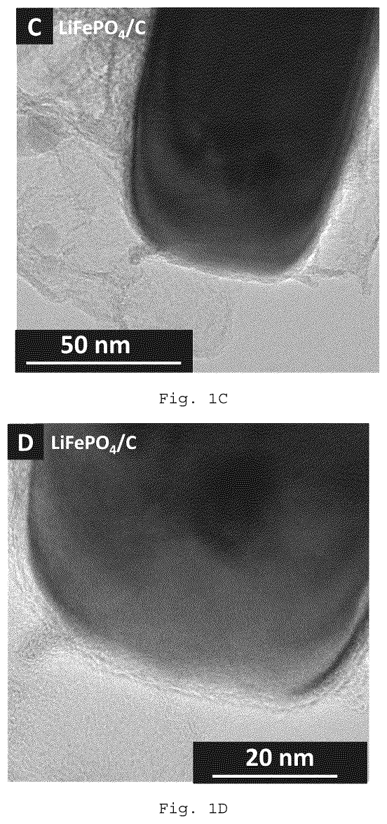

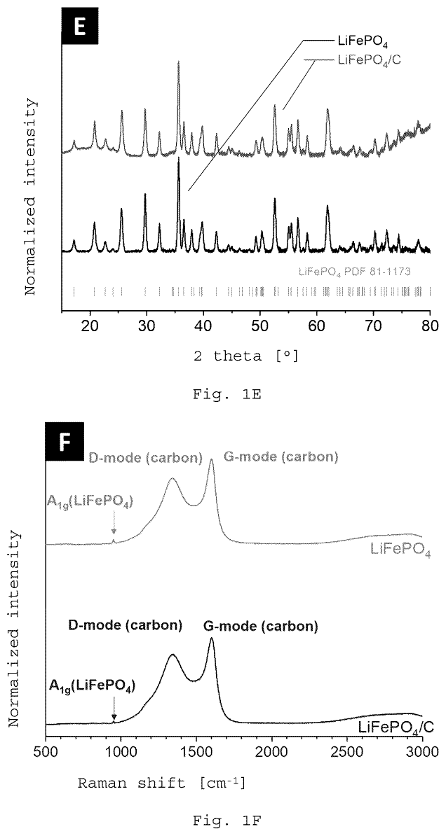

FIG. 1A-F Transmission electron micrographs of LiFePO₄ (A and B) and LiFePO₄/C (C and D); (E) X-ray diffractograms (F) and Raman spectra of LiFePO₄ and LiFePO₄/C;

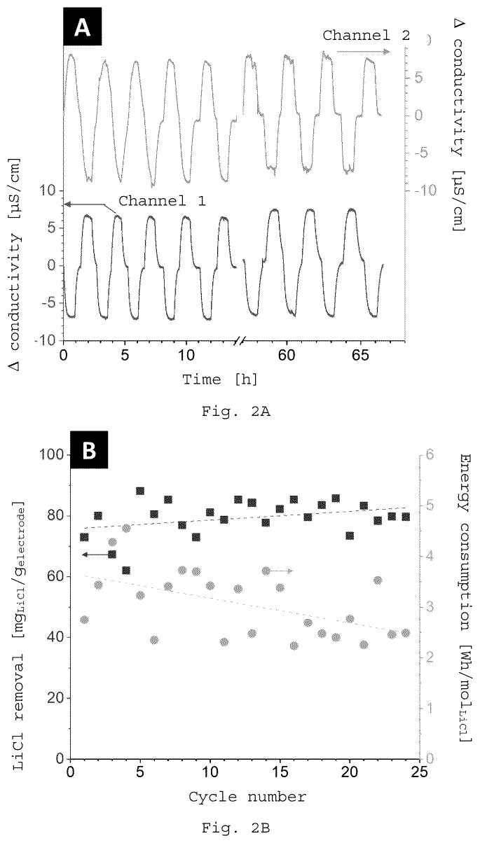

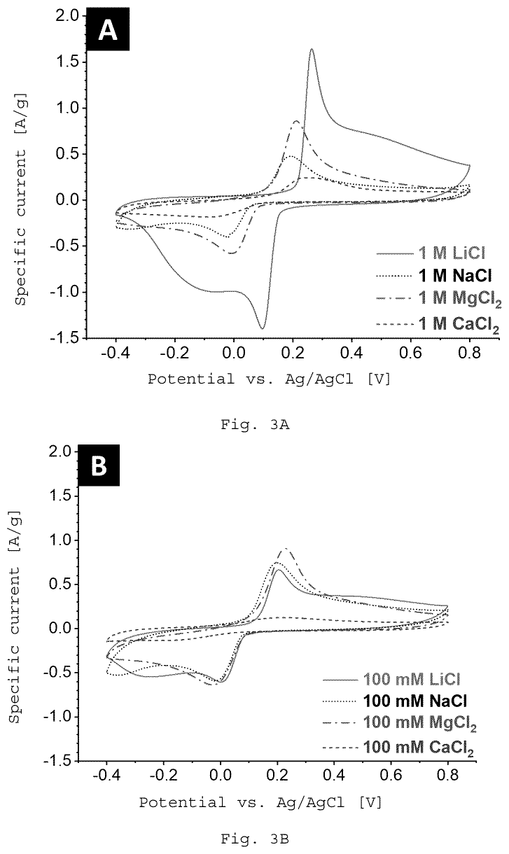

FIG. 2A/B (A) Change in conductivity in the two channels and (B) lithium chloride removal capacity (left axis, squares) and energy consumption of the whole cell in 24 cycles in aqueous 10 mM LiCl (right axis, circles);

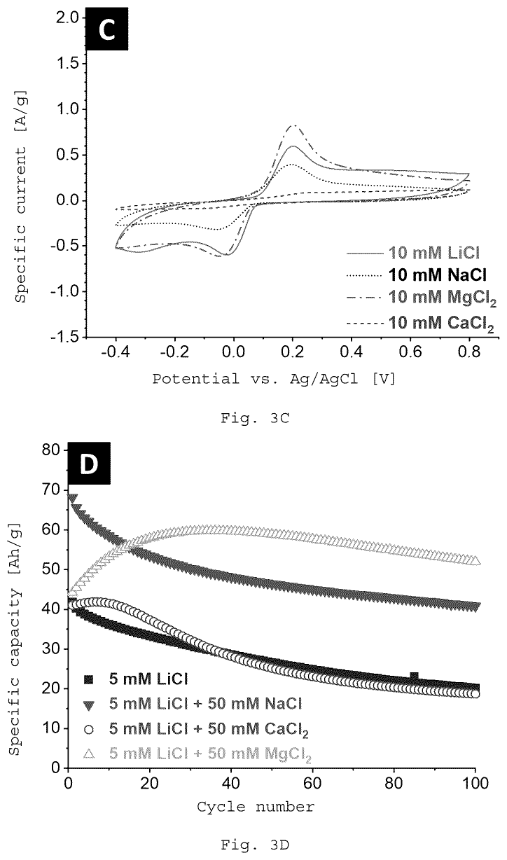

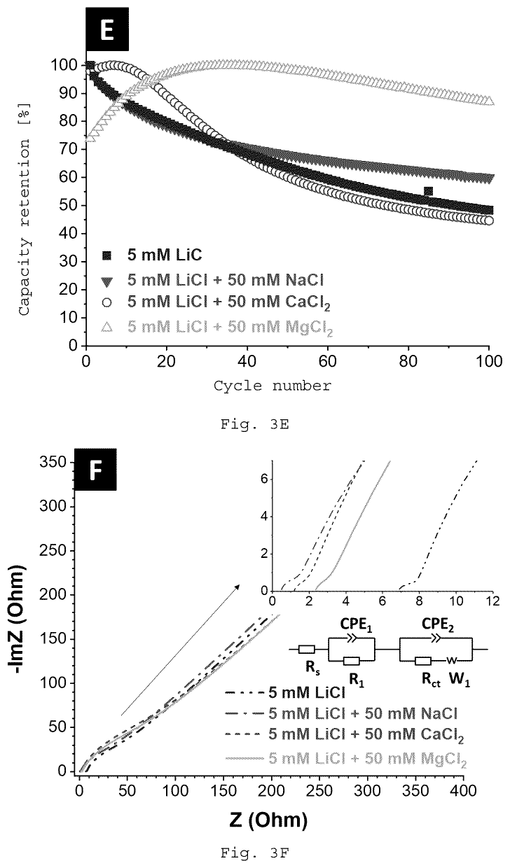

FIG. 3A-F Cyclic voltammograms (1 mV/s) of LiFePO₄ in aqueous electrolytes having a concentration of LiCl, NaCl, MgCl₂, and CaCl₂ of 1 M (A), 100 mM (B), and 10 mM (C). (D and E) Specific capacity of LiFePO₄ for selected LiCl mixtures recorded at 0.1 A/g (D: absolute value; E: relative value). (F) Nyquist plot and equivalent circuit for the system of the mixed electrolyte system;

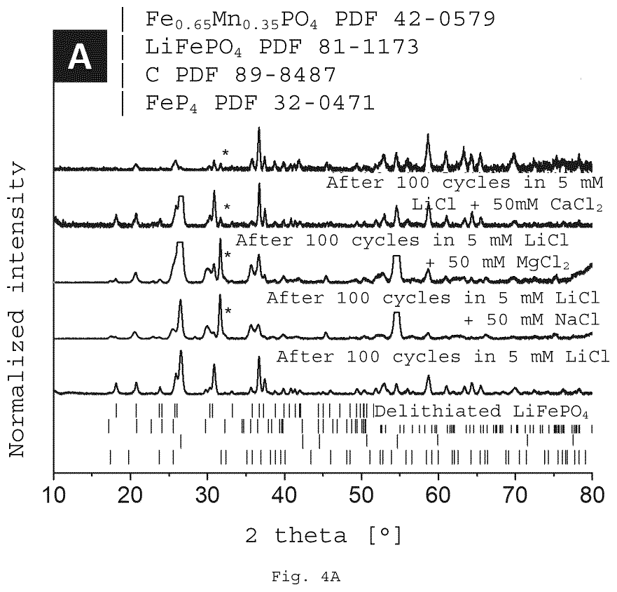

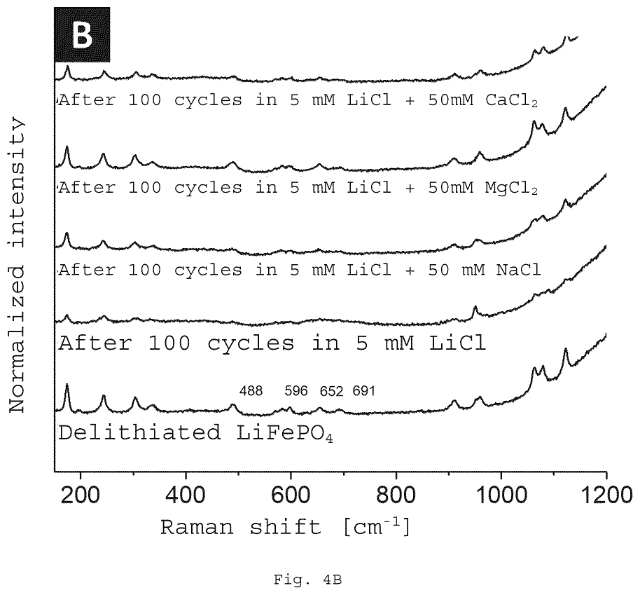

FIG. 4A/B (A) Post-mortem X-ray diffraction patterns and (B) Raman spectra of delithiated LiFePO₄ after 100 cycles in various electrolytes;

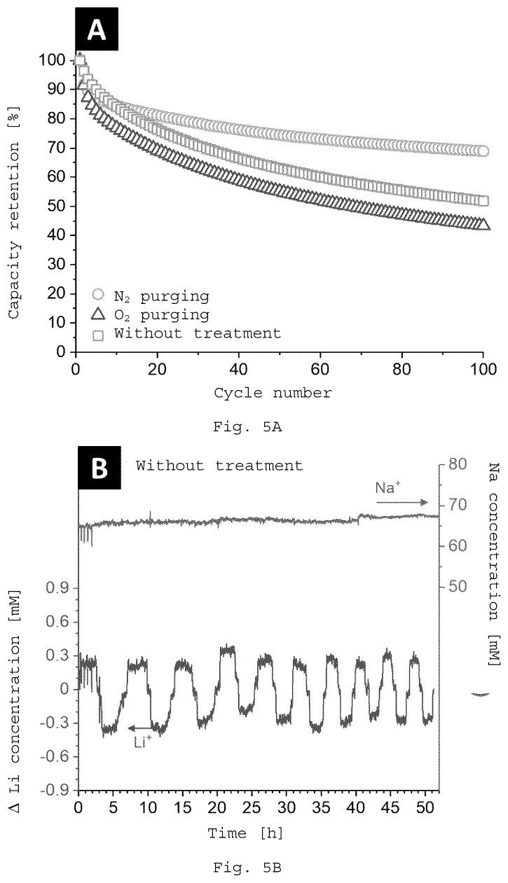

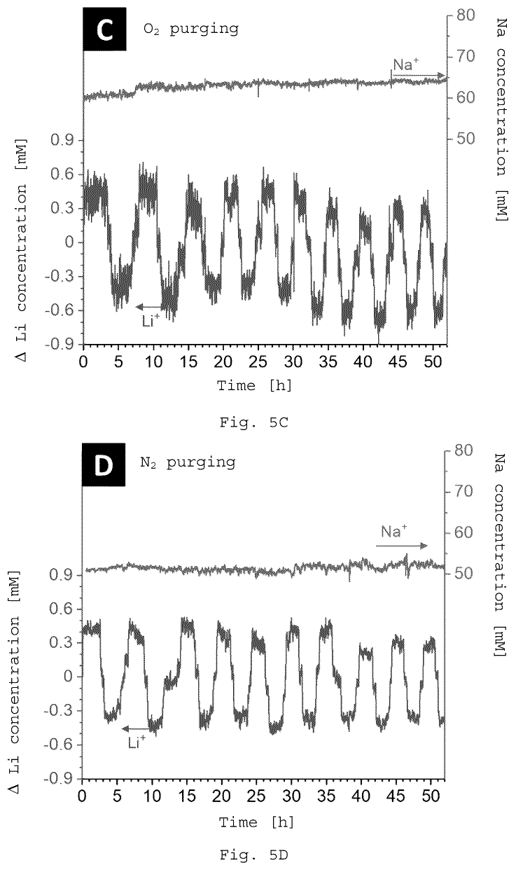

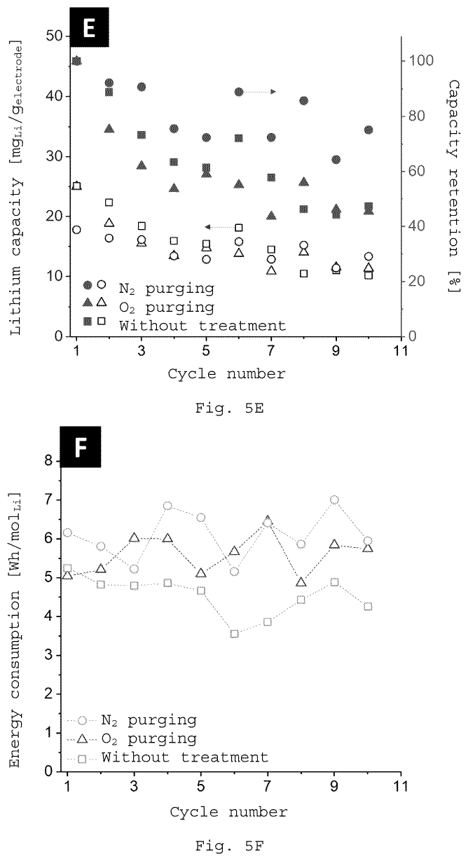

FIG. 5A-F (A) Comparison of the stability of LiFePO₄ in 5 mM LiCl+50 mM NaCl with N₂ purging, O₂ purging or no pretreatment, operated in a three-electrode arrangement at 0.1 A/g. (B to D): Outflow concentration of lithium and sodium using LiFePO₄ electrodes in 5 mM LiCl+50 mM NaCl (B) without treatment, (C) with O₂ purging or (D) with N₂ purging. (E) Comparison of lithium extraction capacity and corresponding capacity retention of LiFePO₄ in 5 mM LiCl+50 mM NaCl without treatment, with O₂ purging or with N₂ purging. (F) Energy consumption of LiFePO₄ in 5 mM LiCl+50 mM NaCl without treatment, with O₂ purging, and with N₂ purging;

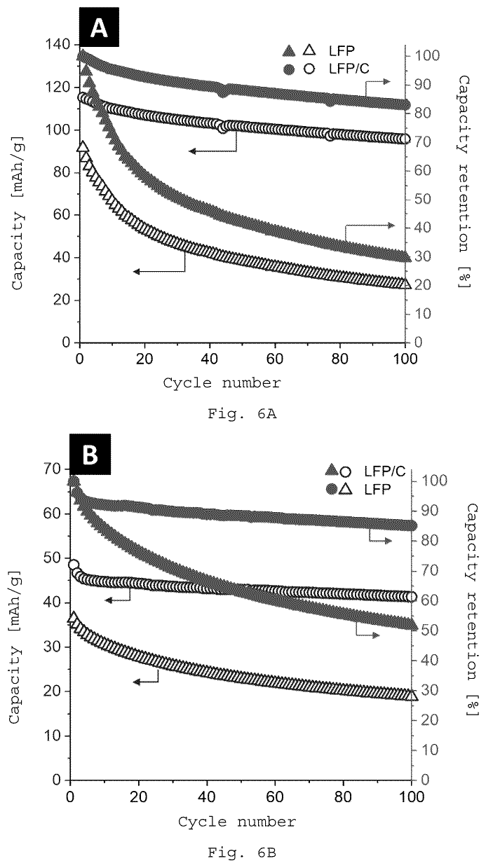

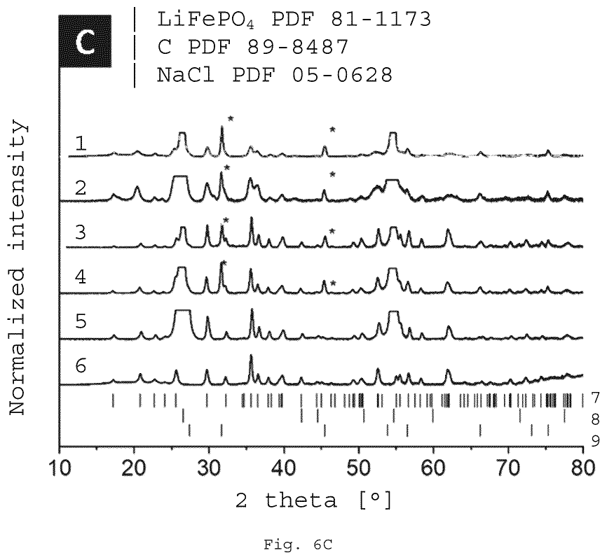

FIG. 6A-F Comparison of the stability of LiFePO₄ and LiFePO₄/C in (A) 1 M LiCl and (B) 5 mM LiCl+50 mM NaCl solution in a three-electrode system at 0.1 A/g. (C) Postmortem X-ray diffractogram of LiFePO₄ and LiFePO₄/C after 100 cycles in 1 M LiCl and 5 mM LiCl+50 mM NaCl solution (1: LiFePO₄ after 100 cycles in 5 mM LiCl+50 mM NaCl; 2: LiFePO₄/C after 100 cycles in 5 mM LiCl+50 mM NaCl; 3: LiFePO₄ after 100 cycles in 1 M LiCl; 4: LiFePO₄C after 100 cycles in 1 M LiCl; 5: LiFePO₄ electrode; 6: LiFePO₄/C powder; 8: C PDF 89-8487; 7: LiFePO₄ PDF 81-1173; 9: NaCl PDF 05-0628); (D) Outflow concentration of lithium and sodium using LiFePO₄/C electrodes in 5 mM LiCl+50 mM NaCl with N₂ purging. (E) Lithium separating capacity and retention in 5 mM LiCl+50 mM NaCl of LiFePO₄/C or LiFePO₄ in 5 mM LiCl+50 mM NaCl with N₂ purging. (F) Energy consumption in 5 mM LiCl+50 mM NaCl from LiFePO₄/C or LiFePO₄;

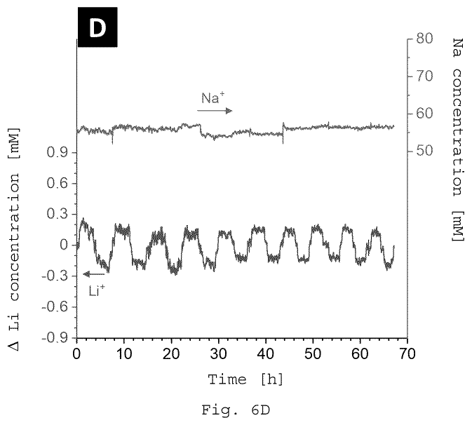

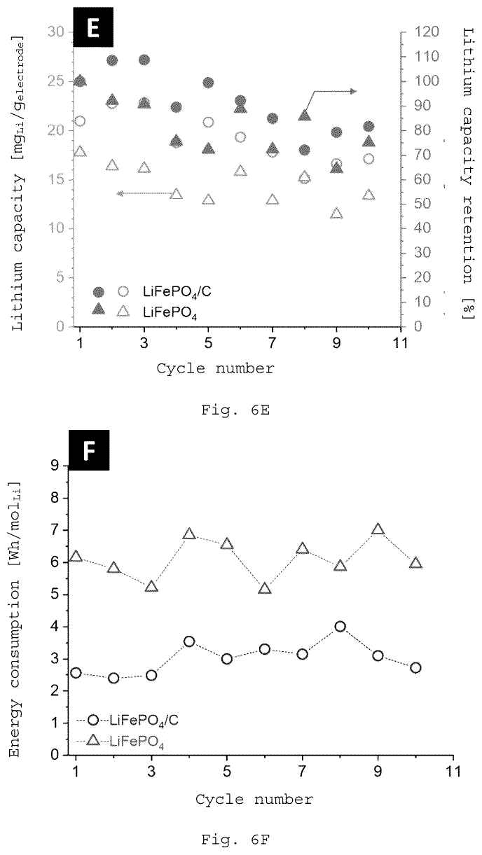

FIG. 7A/B Calibration curves (relationship of ion concentration and characteristic peak intensity) for lithium (A) and sodium (B);

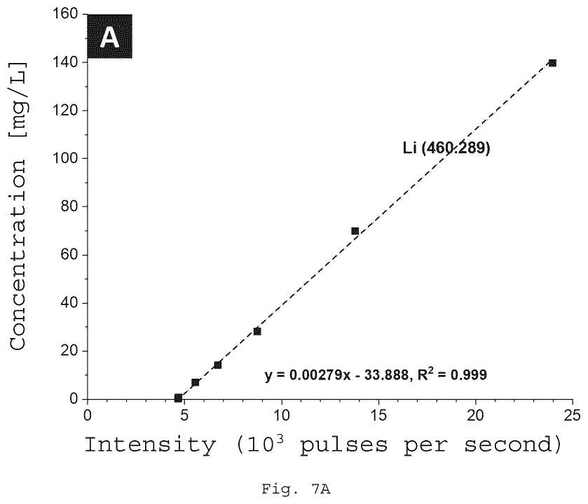

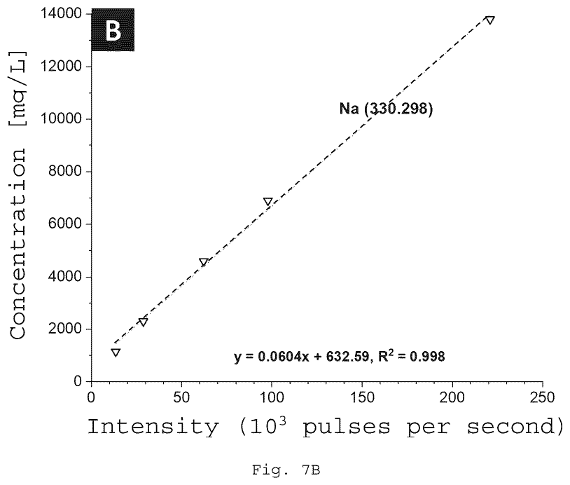

FIG. 8 Raman spectra of delithiated LiFePO₄ at various points in a sample;

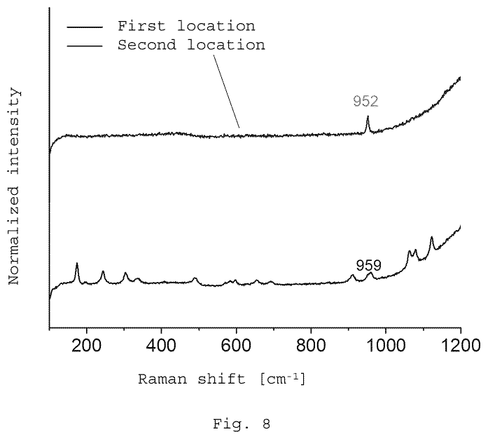

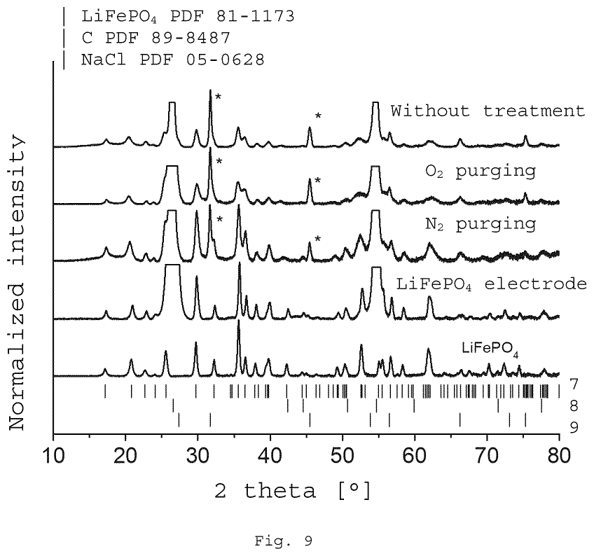

FIG. 9 Post-mortem X-ray diffractograms of LiFePO₄ after 100 cycles in 5 mM LiCl+50 mM NaCl with N₂ purging, with O₂ purging, and without pre-treatment; (7: C PDF 89-8487; 8: LiFePO₄ PDF 81-1173; 9: NaCl PDF 05-0628)

### MATERIALS AND METHODS

Synthesis of LiFePO₄, LiFePO₄/C, and Electrode Preparation

Commercially available LiFePO₄ (SGd-Chemie) having a specific surface area of 16 m²/g was used. LiFePO₄/C was synthesized by a two-step procedure in analogous manner to Ma, Z.; Fan, Y.; Shao, G.; Wang, G.; Song, J.; Liu, T., In situ catalytic synthesis of high-graphitized carbon-coated LiFePO₄ nanoplates for superior Li-ion battery cathodes. ACS Applied Materials & Interfaces 2015, 7, (4), 2937-2943. First, the LiFePO₄ as delivered (0.4 g) and 0.21 g of ethylene glycol were dispersed in 10 mL of citric acid solution (0.18 g anhydrous citric acid in 10 mL distilled water) while stirring. LiFePO₄ was added last. The suspension was heated to +80° C. for 3 hours to obtain the LiFePO₄ coated with the alkyl ester compound. The alkyl ester coating was then carbonized in two heating steps in argon. First, the sample was heated to +200° C. for 2 h to remove the water in the materials, then the sample was heated to +700° C. and held at this temperature for 6 h to obtain the LiFePO₄-carbon hybrid.

The electrodes were produced by mixing and grinding the active material (LiFePO₄ or LiFePO₄/C), acetylene black, and polyvinylidene fluoride (Sigma-Aldrich) in a mass ratio of 8:1:1 in 1-methyl-2-pyrrolidinone (Sigma-Aldrich) to form a slurry. The slurry was coated onto graphite paper (SGL, thickness 300 μm) with a doctor blade (thickness 200 μm) and then left overnight at room temperature in the hood. The electrode was then dried at +80° C. in a vacuum oven for 24 h.

### Electrochemical Measurements

The electrochemical behavior of LiFePO₄ and LiFePO₄/C was investigated in a custom-built cell in a three-electrode system. Electrodes 12 mm in diameter made of LiFePO₄, LiFePO₄/C or activated carbon electrode (YP-80F, Kuraray) were used as the working electrode (LiFePO₄, LiFePO₄/C) or counter electrode (activated carbon). The electrodes were arranged in a sandwich and separated in the cell body by a glass fiber mat (diameter 13 mm, GF/A, Whatman). An Ag/AgCl reference electrode (3 M KCl, BASi) was mounted laterally in the cell body. Before the test, the assembled cells were filled with various electrolytes. For single salt electrolytes, 1 M LiCl, 1 M MgCl₂, 1 M CaCl₂ and 1 M NaCl were used. For the mixed salt electrolyte, 5 mM LiCl and 50 mM MeClₓ (Me=Na, Ca, Mg, X corresponding to the Me charge) were used.

The cell was connected to the VSP300 potentiostat/galvanostat (Bio-Logic) and the cyclic voltammogram applied versus Ag/AgCl at a scan rate of 0.1 mV/s and a cutoff potential of −0.4 V to +0.8 V. To test the performance stability of LiFePO₄ and LiFePO₄/C, potential-limited galvanostatic charge/discharge measurements were performed. Before the electrochemical operation, the electrolyte was continuously purged with nitrogen gas for 1 h to remove the dissolved oxygen in the electrolyte (only when investigating the effect of oxygen). The dissolved oxygen concentration after the gas purge is shown in Table 2.

In addition, the electrodes were delithiated prior to the electrochemical test to prevent a rise in the lithium concentration in the electrolyte as a result of the LiFePO₄ and LiFePO₄/C charging process. To delithiate the electrodes, the electrodes were charged with a current of 0.1 A/g and with a cutoff voltage of +0.4 V versus Ag/AgCl in a three-electrode system in 1 M LiCl electrolyte. Electrochemical impedance spectroscopy (EIS) was measured vs. Ag/AgCl at the formal potential in the frequency range from 1 MHz to 10 MHz and with an excitation voltage of 5 mV.

The conductivities of LiCl, MgCl₂, CaCl₂, and NaCl at various concentrations were tested using a microcell electrochemical HC cell with Pt electrodes (RHD Instruments) and a ModuLab electrochemical workstation (Solartron Analytical). 0.9 mL of each electrolyte was added to the measuring cup with a syringe and the Pt electrode crucible was then closed. A heat-conducting paste (Eurotherm 2000) was employed in the center of the closed cell and base unit to improve heat transfer therebetween. The potentiostatic impedance at each temperature was measured once the temperature had stabilized for 10 minutes. The impedance was measured from 1 Hz to 3 MHz at open circuit potential (OCV) at various temperatures from +10° C. to +60° C. in steps of Δ10° C. and at +25° C. The conductivity and activation energy values were calculated according to equations 1 and 2.

$$σ = \frac{l}{AR} \qquad Equation 1$$

where σ stands for the conductivity (S/cm), R for the resistance (Ω), A for the area (cm²), and 1 is the length (cm). The value for 1/A was obtained from a 0.1 M KCl aqueous standard (VWR) having a conductivity of 12.880 mS/cm at +25° C.

$$σ = \frac{A}{T} {e}^{( - {E}_{a} / k T )} \qquad Equation 2$$

where σ is the conductivity, T the temperature (K), A is as obtained in the experiment, k the Boltzmann constant (1.380649×10⁻²³ J/K), and Eₐ the activation energy (kJ/mol).

### Lithium Selectivity Experiments

Lithium extraction experiments were performed in a multichannel cell. Two water channels were created through the seal (area=6.76 cm², thickness=500 μm) filled with glass fiber mat (GF/A, Whatman) and separated by an anion-exchange membrane (FAS-PET-130, Fumatech). The LiFePO₄ or LiFePO₄/C electrodes were situated at the end of the channel and were contacted with the graphite current collector. Before the experiment, one electrode was delithiated by the method described above. The channel with a pretreated electrode is referred to as “channel 1” and the other as “channel 2”.

A 10 liter tank containing LiCl (10 mM) was used as feed water at a flow rate of 3 mL/min, while a constant current (40 mA/g) was applied at a cell voltage between −0.4 V and +0.4 V using a VSP300 potentiostat/galvanostat system. Throughout the experiment, the electrolyte was continuously purged with N₂ gas to remove dissolved oxygen. The mass of the electrode was 8 mg and the change in the conductivity and pH of two channels was recorded online by conductivity sensors (Metrohm, PT1000) and pH sensors (WTW SensoLyt 900P) respectively. Lithium is extracted throughout the cycle, accordingly the lithium removal capacity and energy consumption of the cell in one cycle were calculated according to equations 3 and 4.

$$Lithium chloride extraction capacity ( {mg}_{LiCl} / {e}_{Electrode} ) = \frac{v \cdot {M}_{LiCl}}{1000 {m}_{total}} \int Δ {c}_{Channel 1} dt + Δ {c}_{channel 2} dt \qquad Equation 3$$

where v is the flow rate (mL/min), M_{LiCl} the molecular weight of LiCl (42.4 g/mol), mₜₒₜₐₗ the mass of the electrodes (g), t the time (min), and Δc_{channel1} and Δc_{channel2} the change in the LiCl concentration (mmol/L) in channel 1 and channel 2 respectively.

$$Energy consumption ( Wh / {mol}_{LiCl} ) = \frac{- \int Δ E dq \cdot 1000}{3.6 \cdot v \cdot \int {ac}_{channel 1} dt + {c}_{channel 2} dt} \qquad Equation 4$$

where ΔE is the cell voltage (V), q the charge (A-s), v the flow rate (mL/min), t the time (min), and Δc_{channel1} and Δc_{channel2} the change in the LiCl concentration (mmol/L) in channel 1 and channel 2 respectively.

To investigate the selectivity and stability of LiFePO₄ and LiFePO₄/C, we used an electrolyte containing 5 mM LiCl and 50 mM NaCl and having a volume of 10 L. The outlet of channel 2 was connected to an inductively-coupled plasma optical emission spectrometer (ICP-OES, ARCOS FHX22, SPECTRO Analytical Instruments) to quantify the change in concentration of the cations. The mass of the electrodes was about 18 mg; a low specific current of 30 mA/g and a flow rate of 1.2 mL/min were used to amplify the ICP signal. The calibration curve was constructed according to the correlation between the intensity of the individual wavelength and the concentration of the solution (FIGS. 7A and 7B). The measured intensities from the extracted sample were converted into concentration profiles. The charging and discharging processes had opposite courses and the potential for energy recovery was negligible, therefore the amount of lithium extracted and the energy consumption were calculated according to equations 5 and 6 in a half cycle in order to assess the performance of LiFePO₄ and LiFePO₄/C.

$$Lithium chloride extraction capacity ( {mg}_{Li} / {g}_{electrode} ) = \frac{v \cdot {M}_{LiCl}}{1000 {m}_{total}} \int Δ {c}_{Channel 2} dt \qquad Equation 5$$

where v is the flow rate (mL/min), M_{Li} the molecular weight of Li (6.99 g/mol), mₜₒₜₐₗ the mass of the electrode (g), t the time over the lithium extraction step (min), and Δc_{channel2} the change in the Li⁺ concentration (mM) in channel 2.

$$Energy consumption ( Wh / {mol}_{Li} ) = \frac{- \int Δ E dq \cdot 1000}{3.6 \cdot v \cdot \int {c}_{channel 2} dt} \qquad Equation 6$$

where ΔE is the cell voltage (V), q the charge (A·s), v the flow rate (mL/min), t the time over the lithium extraction step (min), and c_{channel2} the Li concentration (mM) in channel 2.

### Material Characterization

The surface morphology of LiFePO₄ and LiFePO₄/C was investigated by scanning electron microscopy (JEOL JSM 7500F) at 1 kV. X-ray diffractometry was performed in a D8 Advance diffractometer (Bruker AXS) with a copper X-ray source (Cu-Kα, 40 kV, 40 mA) and a Goebel mirror in point focus (0.5 mm). Raman spectra were recorded with a Renishaw inVia system using a Nd:YAG laser with an excitation wavelength of 532 nm. The spectral resolution was 1.2 cm⁻¹, and the diameter of the laser spot on the sample was about 2 μm at a total power consumption of 0.2 mW.

Characterization of LiFePO₄ and LiFePO₄/C

FIG. 1A shows transmission electron micrographs of LiFePO₄. LiFePO₄ particles are typically about 300 nm long and about 150 nm broad. Discernible at higher resolution (FIG. 1B) are lattice bands with the typical spacing of 0.34-0.35 nm in alignment with the (111) and (021) planes of LiFePO₄. LiFePO₄/C shows the ubiquitous presence of the carbon that coats the LiFePO₄ particles (FIGS. 1C and 1D).

FIG. 1E shows the X-ray diffractogram of LiFePO₄ and LiFePO₄/C. The diffraction patterns of LiFePO₄/C are the same as those of LiFePO₄, identified as an orthorhombic phase (PDF 81-1173), which indicates that the carbon-coating process does not destroy the inherent structure of LiFePO₄. FIG. 1F shows the Raman spectra of LiFePO₄ and LiFePO₄/C. The band at 952 cm⁻¹ is attributable to the symmetric stretching of the P—O bonds of LiFePO₄. And the peaks at 1338 cm⁻¹ and 1598 cm⁻¹ correspond to the D band and G band of carbon respectively. The D band (disordered peak) is attributable to the A_{1g} vibrational mode and the G band (graphitic peak) to the E_{2g} vibrational mode of C—C bond stretching. Therefore, both commercial LiFePO₄ and LiFePO₄/C show the presence of incompletely graphitic carbon; in the case of the former, carbon is a minority phase.

Lithium Extraction from LiFePO₄ in Aqueous 10 mM LiCl

The Li removal capacity of LiFePO₄ in aqueous 10 mM LiCl was quantified. When a specific current of 30 mA/g is applied during charging, the conductivity in channel 1 decreases, while the conductivity in channel 2 increases (FIG. 2A). This corresponds to reduction of the cathode with uptake of lithium and oxidation of the anode with release of lithium into the feed water stream (equation 7). The reverse process is observed during the discharge process. The lithium extraction capacity of the cell does not decline during 24 cycles with an average capacity of 79±6 mg_{LiCl}/electrode, corresponding to 13±1 mg_{L}i/electrode (FIG. 2B), suggesting that LiFePO₄ is stable in deaerated aqueous 10 mM LiCl. The average energy consumption of the cell is 3 Wh/mol_{LiCl}, corresponding to 3 Wh/mol_{Li}.

Li₁₋ₓFePO₄+xLi⁺+xe⁻=LiFePO₄ Equation 7

Effect of Other Cations by Comparison with Lithium

Cyclic voltammetry was carried out to investigate the selectivity behavior of LiFePO₄ toward Li⁺ by comparison with other cations. This was done by comparing the electrochemical performance in various single-cation electrolytes. As shown in FIGS. 3A, 3B, and 3C, a pair of redox peaks occurs in all electrolyte types. The measured peak current was lowest when using an aqueous 1 M CaCl₂ electrolyte. With 1 M LiCl, the redox peak currents are highest and the peak potentials are shifted to a more positive range by comparison with the other electrolytes, which could be attributable to the contribution of lithium in the solution leaching from the electrode.

To further quantify the potential shift, the formal potential (E_{1/2}) was investigated. As shown by Table 3, the formal potential in LiCl solution decreases with decreasing concentration. During the charging process (the first electrochemical process during cyclic voltammetry), the Li⁺ in LiFePO₄ is released into the electrolyte. Therefore, in tests in electrolytes containing other cations, such as NaCl, MgCl₂ or CaCl₂, the cyclic voltammograms and the formal potential are almost identical.

In order to reduce the loss of additional lithium ions from the electrode to the electrolyte and in order to compare electrolytes having differing concentrations, the LiFePO₄ electrodes were delithiated prior to the galvanostatic charge/discharge test. A significant fall in the initial capacity of LiFePO₄ was observed in all electrolytes (FIGS. 3D and 3E). The capacity decreases most slowly in the mixed solution of Li⁺ and Na⁺ and most rapidly in Ca²⁺-containing electrolytes, with a retention after 100 cycles of 60% and 46% respectively. The capacity in 5 mM LiCl+50 mM MgCl₂ solution initially increases and then decreases; the increase may be attributable to the intercalation of trace amounts of Mg²⁺. By comparison with other cations, Mg²⁺ intercalates into the structure of LiFePO₄ more readily. However, the intercalation of both Mg²⁺ and Li⁺ is not fully reversible, consequently capacity continues to decrease. To investigate why the capacity of LiFePO₄ electrodes decreases during cycles, the post-mortem X-ray diffractogram of delithiated LiFePO₄ charging and discharging 100 cycles in various electrolytes was measured.

In addition to the influence on stability, cations other than Li⁺ also influence the kinetics obtained from electrochemical impedance measurements. The Nyquist plots consist of two semicircles and a line (FIG. 3F). The semicircle at high frequency represents the capacity response of the electrolyte, thus it occurs in a significant amplitude only when the electrolytes are investigated with low concentration. The semicircle at medium frequency represents the charge-transfer resistance (R_{ct}). The oblique line at low frequency represents the Warburg impedance (W₁), which corresponds to the diffusion of lithium ions. The value for R_{ct} and w₁ is calculated according to the simulated circuit as shown in Table 1. Ca²⁺ and Mg²⁺ have an adverse effect on the charge-transfer process, with R_{ct} values of 38.7 Ω·cm² and 37.3 Ω·cm² respectively, which are almost twice as high as the R_{ct} value in pure 5 mM LiCl (20.1 Ω·cm²). The R_{ct} values in 5 mM LiCl and 50 mM NaCl are similar to those in pure LiCl electrolyte. The effect of other cations on the Warburg impedance follows the pattern observed for the R_{ct} value, and the Warburg impedances in Mg²⁺- and Ca²⁺-containing electrolyte are higher than those in Na⁺-containing and pure LiCl. This result indicates that lithium ions diffuse into the liquid side less easily in the former electrolytes than in the latter ones. The differing effects have their origin in the differing conductivities of the cations.

As can be seen in FIG. 4A, the delithiated LiFePO₄ is composed of heterosite FePO₄ and LiFePO₄, since the LiFePO₄ is not fully delithiated. This result is in agreement with the Raman data (FIG. 8). When Raman measurements are carried out at two randomly selected points, there is only one peak at point 1 (952 cm⁻¹), this being consistent with the Raman spectra of LiFePO₄ (FIG. 1F). In other places, the observed peaks correspond to FePO₄. After 100 cycles in 5 mM LiCl, some diffraction peaks such as the 37.4 ° 2θ ((211) plane of heterosite FePO₄) disappear, indicating break-up of the structure of FePO₄. Different behavior is observed after 100 cycles in Ca²⁺-containing electrodes, in which the diffraction peaks at 18.13° 2θ, corresponding to the (020) plane of heterosite FePO₄, disappear, pointing to significant loss of capacity. FIG. 4B shows the Raman spectra of the electrodes after 100 cycles in various electrolytes. After charging/discharging in NaCl, LiCl, and CaCl₂ electrolytes, the peaks at 488 cm⁻¹ (Li cage/asymmetric bending of PO₄³⁻), 596 cm⁻¹ (asymmetric bending of PO₄³⁻, ν₄), 652 cm⁻¹ (symmetric bending of PO₄³⁻, ν₂), and 691 cm⁻¹ are not apparent, indicating breakage of the P—O bond; this is a further reason for the decline in performance of LiFePO₄, namely the loss of oxygen species.

### Effect of the Oxygen Content in Electrolytes

A mixed electrode containing 5 mM LiCl and 50 mM NaCl as feed water was used to investigate the influence of the oxygen content on the stability of LiFePO₄. The spur for this choice was the observation that sodium ions have the lowest influence on the stability of LiFePO₄. First, the stability of LiFePO₄ at 100 mA/g was tested with a potential range of −0.4 V to +0.5 V versus Ag/AgCl in 5 mM LiCl+50 mM NaCl solution, which was continuously purged with O₂ and N₂ prior to the electrochemical process. After 100 cycles, LiFePO₄ retains 69% of its initial capacity in the N₂-purged electrolytes, whereas the capacity retention values in the O₂ purged electrolytes and in untreated electrolytes are 43% and 52% respectively (FIG. 5A). This suggests that dissolved O₂ in the electrolyte significantly accelerates the loss in performance of LiFePO₄.

The outflow solution was continuously analyzed by online monitoring using inductively-coupled plasma optical emission spectroscopy (ICP-OES). As shown in FIGS. 5B, 5C, and 5D, LiFePO₄ retains good selectivity toward lithium throughout, irrespective of the oxygen content. Similar to the trend in the specific capacity (FIG. 5A), the LiFePO₄ tested in feed water with continuous N₂ purging was the most stable, with 70% capacity retention after 10 cycles (FIG. 5E). The lithium extraction capacity is only about half the initial value in feed water without any treatment, which is slightly higher than in the feed water with continuous O₂ purging. At higher oxygen content, the capacity decreases with a greater amplitude. In contrast to the Li⁺ extraction/recovery capacity, the energy consumption is stable during the 10 cycles, as shown in FIG. 5F. This result indicates that the oxygen content has little influence on the energy consumption of the system, but a large influence on the structural and chemical stability of LiFePO₄ itself.

To investigate how dissolved oxygen in the electrolyte influences the stability of LiFePO₄, X-ray diffraction was used. This examined structural changes in the electrode material after 100 cycles in an electrolyte consisting of 5 mM LiCl and 50 mM NaCl (FIG. 9). Unlike in the measurement of the powder only, the cast electrodes show strong reflections from the graphite paper (26.5° 2θ and 54.6° 2θ), consequently the diffraction pattern was normalized to the peaks not associated with the graphite foil. Compared to the LiFePO₄ and LiFePO₄ electrode, all electrodes exhibit after 100 cycles two additional peaks at 31.7° 20 and 45.5° 2θ, corresponding to the (200) plane and the (220) plane respectively; these peaks relate to the presence of a highly symmetrical phase (residual salt). The electrode cycled in the electrolyte with less dissolved oxygen (N₂ purging) shows lower peak broadening compared to the sample with O₂ purging. The higher amount of dissolved oxygen seemingly results in greater degradation of the LiFePO₄ material.

### Improved Stability Through Carbon Coating of LiFePO₄

To increase the stability of LiFePO₄, LiFePO₄ had layers of carbon bonded onto it to prevent attack by oxygen. FIG. 6A shows the difference between LiFePO₄ and LiFePO₄/C in aqueous 1 M LiCl. As can be seen, the capacity of LiFePO₄/C decreases slightly from 115 mAh/g to 95 mAh/g, with retention of 83% of the initial capacity after 100 cycles. By way of comparison: LiFePO₄ without carbon coating retains only 30% of the initial capacity, with a decline from 92 mAh/g to 27 mAh/g after 100 cycles. Performance at low concentration (5 mM LiCl+50 mM NaCl) is similar (FIG. 6B). LiFePO₄/C still has 85% capacity in the first cycle (41 mAh/g and 48 mAh/g), whereas LiFePO₄ retains only 52% of the initial value.

FIG. 6C shows the X-ray diffractograms of LiFePO₄/C and LiFePO₄ electrodes after testing in 1 M LiCl and 5 mM LiCl+50 mM NaCl.

To investigate further whether the carbon coating is able to improve the stability of LiFePO₄ during lithium extraction, the performance of LiFePO₄/C in 10 mM LiCl and 5 mM LiCl+50 mM NaCl solution (continuous N₂ purging) was tested using the rocking chair cell. In the same way as LiFePO₄, LiFePO₄/C also exhibits good selectivity toward lithium (FIG. 6D). However, LiFePO₄/C has a higher lithium extraction capacity (21.0 mg_{Li}/g electrode compared to 17.8 mg_{L}i/g electrode in the first cycle) and better stability, with 82% retention after carbon coating, as shown in FIG. 6E. The higher capacity of LiFePO₄/C could be due to the carbon coating improving the electronic conductivity of the LiFePO₄ (Li, J.; Qu, Q.; Zhang, L.; Zhang, L.; Zheng, H., A monodispersed nano-hexahedral LiFePO₄ with improved power capability by carbon-coatings. Journal of alloys and compounds 2013, 579, 377-383), i.e. the active materials can be fully utilized at high current. In addition, the carbon layer is able to block attack by oxygen and OH⁻ and increase the stability of LiFePO₄ (He, P.; Liu, J.-L.; Cui, W.-J.; Luo, J.-Y.; Xia, Y.-Y., Investigation on capacity fading of LiFePO₄ in aqueous electrolyte. Electrochimica Acta 2011, 56, (5), 2351-2357). In addition, the additional carbon present in nanohybridized form in LiFePO₄/C could effectively reduce the resistance of LiFePO₄, which lowers energy consumption (FIG. 6F). The average energy consumption of LiFePO₄/C in 10 cycles is 3.0±0.5 Wh/mol_{Li}.

The influence of the cations and of dissolved oxygen on the stability of LiFePO₄ was investigated in a symmetrical cell (i.e. LiFePO₄ paired with LiFePO₄). Cations other than Li⁺ in brine, such as Na⁺, Mg²⁺, and Ca²⁺, influence the stability and electrochemical properties of LiFePO₄. Of these, Ca²⁺ has the most adverse effect, and Na⁺ shows no apparent influence in the potential range from −0.4 V to +0.8 V. The stability and electrochemical properties of LiFePO₄ are impaired by Ca²⁺. Dissolved oxygen likewise exacerbates the fading of LiFePO₄. Lowering the concentration of dissolved oxygen (N₂ purging) dramatically increases the capacity retention in 10 cycles in 5 mM LiCl±50 mM NaCl from 47% to 70%. After carbon coating, the retention increases further to 82% and energy consumption falls to 3.0±0.5 Wh/mol_{Li}. These two methods improve the performance stability of LiFePO₄ as a material for lithium extraction. Whereas lowering dissolved oxygen may not be practical in to-scale applications, the carbon coating of LiFePO₄ represents a simple and very promising approach for larger scale uses too.

TABLE 1
Adjusted values for delithiated LiFePO₄ in various electrolytes
according to the equivalent circuit diagram.

| | Rₛ | R₁ | R_{ct} | W₁ (Ω · | | |
|---|---|---|---|---|---|---|
| Electrolyte | (Ω) | (Ω) | (Ω) | s^{-1/2}) | χ² | χ²/lZl |
| 5 mM LiCl | 6.8 | 1.1 | 40.0 | 63.4 | 315.2 | 1.67 × 10⁻² |
| 5 mM LiCl + | 0.4 | 1.0 | 38.7 | 51.8 | 210.5 | 1.36 × 10⁻² |
| 50 mM NaCl | | | | | | |
| 5 mM LiCl + | 2.2 | 0.9 | 74.2 | 76.2 | 265.7 | 5.98 × 10⁻³ |
| 50 mM MgCl₂ | | | | | | |
| 5 mM LiCl + | 1.1 | 0.8 | 77.0 | 71.4 | 669.4 | 7.24 × 10⁻³ |
| 50 mM CaCl₂ | | | | | | |

TABLE 2
Concentration of dissolved oxygen
after O₂ purging and N₂ purging

| Condition | O₂ concentration (ppm) |
|---|---|
| Initial | 8.8 |
| O₂ purging for 24 h | 12.5 |
| N₂ purging for 24 h | 4.0 |

TABLE 3
Formal potential of LiFePO₄ in LiCl, NaCl, MgCl₂,
and CaCl₂ at a concentration of 1M, 100 mM, and 10 mM.

| | Average potential E_{f} |
|---|---|
| Electrolyte | (V vs. Ag/AgCl) |
| 1M LiCl | 0.18 |
| 1M NaCl | 0.08 |
| 1M MgCl₂ | 0.1 |
| 1M CaCl₂ | 0.07 |
| 100 mM LiCl | 0.12 |
| 100 mM NaCl | 0.09 |
| 100 mM MgCl₂ | 0.10 |
| 100 mM CaCl₂ | 0.03 |
| 10 mM LiCl | 0.09 |
| 10 mM NaCl | 0.07 |
| 10 mM MgCl₂ | 0.08 |
| 10 mM CaCl₂ | 0.06 |

### CITED LITERATURE

Kanoh, H.; Ooi, K.; Miyai, Y.; Katoh, S., Electrochemical recovery of lithium ions in the aqueous phase. Separation Science and Technology 1993, 28, (1-3), 643-651.
Pasta, M.; Battistel, A.; La Mantia, F., Batteries for lithium recovery from brines. Energy & Environmental Science 2012, 5, (11), 9487.
Trócoli, R.; Battistel, A.; La Mantia, F., Nickel hexacyanoferrate as suitable alternative to Ag for electrochemical lithium recovery. ChemSusChem 2015, 8, (15), 2514-2519.
Kim, J.-S.; Lee, Y.-H.; Choi, S.; Shin, J.; Dinh, H.-C.; Choi, J. W., An electrochemical cell for selective lithium capture from seawater. Environmental Science & Technology 2015, 49, (16), 9415-9422.
Ma, Z.; Fan, Y.; Shao, G.; Wang, G.; Song, J.; Liu, T., In situ catalytic synthesis of high-graphitized carbon-coated LiFePO₄ nanoplates for superior li-ion battery cathodes. ACS Applied Materials & Interfaces 2015, 7, (4), 2937-2943.
Li, J.; Qu, Q.; Zhang, L.; Zhang, L.; Zheng, H., A monodispersed nano-hexahedral LiFePO₄ with improved power capability by carbon-coatings. Journal of alloys and compounds 2013, 579, 377-383.
He, P.; Liu, J.-L.; Cui, W.-J.; Luo, J.-Y.; Xia, Y.-Y., Investigation on capacity fading of LiFePO₄ in aqueous electrolyte. Electrochimica Acta 2011, 56, (5), 2351-2357.

1. An electrode material for extracting an element ion from a liquid medium, comprising at least one electrode material comprising at least one ion sieve capable of intercalating or releasing an element ion, or a mixture of such ion sieves, the at least one ion sieve being coated with carbon.

2. The electrode material as claimed in claim 1, wherein the element ion is a lithium ion.

3. The electrode material as claimed in claim 1, wherein the ion sieve after uptake of the element ion is a lithium-containing metal oxide or a lithium-containing metal phosphate.

4. The electrode material as claimed in claim 3, wherein the ion sieve is a complex oxide containing lithium and at least one further element comprising Co, Mg, Cr, Mn, Ni, Fe, Al, Mo, V, W or Ti or a lithium iron phosphate.

5. The electrode material as claimed in claim 4, wherein the lithium iron phosphate comprises LiFePO₄, LiₓMe_{y}FePO₄, LiFeMe_{y}PO₄ or a mixture thereof, where Me is Mn, Co, Mo, Ti, Al, Ni, Nb or a mixture thereof and 0<x<1; and 0<y<1.

6. The electrode material as claimed in claim 1, wherein the carbon layer is obtained by carbonization.

7. The electrode material as claimed in claim 1, wherein the ion sieve is in the form of particles.

8. An electrode for extracting an element ion from a liquid medium, comprising as electrode material as claimed in claim 1.

9. A process for extracting an element ion from a liquid medium, comprising:
providing at least one electrode material as claimed in claim 1, and
controlling intercalation and release of the element ion by applying a voltage.

10. The process as claimed in claim 9, comprising:
a) providing an apparatus for electrodialysis, comprising an electrodialysis cell, dividing the electrodialysis cell into a lithium salt chamber and an alkali chamber by means of an anion-exchange membrane; filling the alkali chamber with salt brine; and filling the lithium salt chamber with a supporting electrolyte solution;
b) placing a conductive substrate coated with a depleted ion sieve in the alkali chamber to act as a cathode, placing a conductive substrate coated with a lithium-intercalated ion sieve in the lithium salt chamber to act as an anode, wherein at least one of the two conductive substrates, includes the ion sieve as the electrode material, and wherein, during the performance of the electrodialysis, the ion sieve is capable of intercalating Li⁺ in the alkali chamber in order to undergo transformation into another lithium-intercalated ion sieve under an external electric potential, the lithium-intercalated ion sieve being capable of releasing Li⁺ into a conductive solution in order to undergo transformation into another ion sieve under the external electric potential, wherein after the intercalation and release of Li⁺ by the depleted ion sieve and the lithium-intercalated ion sieve respectively, enrichment occurs in the lithium salt chamber to afford a lithium-enriched solution.

11. The process as claimed in claim 9, wherein the concentration of the oxygen dissolved in the medium is lowered during the intercalation of the element ion, preferably by purging the medium with nitrogen.

12. An apparatus for performing the process as claimed in claim 9.

13. The use of the electrode material as claimed in claim 1 in a process for extracting an element ion from a liquid medium.

14. A process for extracting an element ion from a liquid medium using at least one ion sieve, comprising:
controlling intercalation and release of the element ion by applying a voltage, and
lowering a concentration of oxygen dissolved in a medium by purging the medium with a non-oxidizing gas.
